(19) United States
(12) Patent Application Publication
(10) Pub. No.: US 2013/0316227 A1
(43) Pub. Date: Nov. 28, 2013

(54) NON-AQUEOUS ELECTROLYTE SECONDARY BATTERY

(71) Applicants: Shun Nomura, Tokushima (JP); Kazuhiro Hasegawa, Hyogo (JP); Takeshi Ogasawara, Hyogo (JP); Hiroyuki Fujimoto, Hyogo (JP)

(72) Inventors: Shun Nomura, Tokushima (JP); Kazuhiro Hasegawa, Hyogo (JP); Takeshi Ogasawara, Hyogo (JP); Hiroyuki Fujimoto, Hyogo (JP)

(73) Assignee: SANYO ELECTRIC CO., LTD., Moriguchi-shi, Osaka (JP)

(21) Appl. No.: 13/983,952

(22) PCT Filed: Feb. 27, 2012
(86) PCT No.: PCT/JP2012/054714

§ 371 Date: Aug. 6, 2013

(30) Foreign Application Priority Data
Feb. 25, 2011 (JP) 2011-039602

(51) Int. Cl. H01M 4/131; H01M 10/0525; H01M 10/0564

(52) U.S. Cl. CPC H01M 4/131; H01M 10/0564; H01M 10/0525
USPC 429/188

(57) ABSTRACT

The present invention is to provide a non-aqueous electrolyte secondary battery that can suppress a decrease in discharge performance and a decrease in residual capacity after storage at charged state under high temperature. The non-aqueous electrolyte secondary battery includes a positive electrode containing a positive electrode active material, a negative electrode containing a negative electrode active material, a non-aqueous electrolyte, and a separator provided between the positive electrode and the negative electrode, the positive electrode active material includes lithium cobaltate and an erbium compound 22 fixed to at least part of the surface of this lithium cobaltate 21, and the non-aqueous electrolyte contains 1,3-bis(isocyanatomethyl)cyclohexane.

### TECHNICAL FIELD

The present invention relates to a non-aqueous electrolyte secondary battery.

### BACKGROUND ART

In recent years, reduction in size and reduction in weight of mobile information terminals, such as a mobile phone, a notebook personal computer, and a PDA, have been rapidly advanced, and a battery functioning as a drive power source therefor has been required to have a higher capacity. Since having a high energy density and a high capacity, a lithium ion battery in which charge and discharge are performed by transfer of lithium ions between a positive electrode and a negative electrode has been widely used as a drive power source for the mobile information terminals as described above.

Concomitant with improvement in function, such as an animation reproduction function and a game function, the mobile information terminals described above tend to require a higher power consumption, and as a result, a drive power source having a higher capacity has been strongly desired. As a method to increase the capacity of the above non-aqueous electrolyte secondary battery, besides a method in which an active material having a high capacity per unit mass is used, and a method in which the amount of an active material to be filled per unit volume is increased, there may be mentioned a method in which a charge voltage of the battery is increased. When the charge voltage of the battery is increased, an oxidation decomposition reaction between a positive electrode active material and a non-aqueous electrolyte is liable to occur.

In order to increase a charge-discharge cycle performance of a non-aqueous electrolyte battery, a technique in which a chain isocyanate compound is contained in a non-aqueous electrolyte has been proposed (see PTD 1).

In addition, in order to suppress the decomposition of a solvent of a non-aqueous electrolyte and the deformation of a battery, a technique in which a diisocyanate compound having an aliphatic carbon chain is contained in a non-aqueous electrolyte has been proposed (see PTD 2).

Furthermore, it has been disclosed that, for example, when a compound containing a rare earth element is dispersed on and adhered to the surface of a positive electrode active material to increase the charge voltage, a reaction between the positive electrode active material and a non-aqueous electrolyte can be suppressed (see PTD 3).

In addition, it has been disclosed that by addition of an appropriate amount of zirconium to lithium cobaltate, a non-aqueous electrolyte secondary battery excellent in charge-discharge cycle performance and high-temperature storage stability can be obtained (see PTD 4).

Furthermore, it has also been disclosed that by adhesion of a zirconium compound to surfaces of lithium cobaltate particles, a charge cut-off voltage can be set to 4.3 V or more without decreasing the charge-discharge cycle performance, and hence a charge-discharge capacity can be increased (see PTD 5).

### CITATION LIST

### Patent Document

PTD 1: Japanese Published Unexamined Patent Application No. 2006-164759

PTD 2: Japanese Published Unexamined Patent Application No. 2007-242411

PTD 3: Japanese Published Unexamined Patent Application No. 2010-245016

PTD 4: Japanese Patent No. 2855877

PTD 5: Japanese Published Unexamined Patent Application No. 2005-85635

### SUMMARY OF INVENTION

### Technical Problem

According to the results obtained by investigation of the above PTDs 1 and 2, the present inventors found that by addition of each of the isocyanate compounds described above to the non-aqueous electrolyte, a voltage drop is increased after a high-temperature continuous charge operation, and a discharge performance thereafter is remarkably degraded.

In addition, the above PTD 3 has also disclosed that for example, when lithium cobaltate is used as a main positive electrode active material to increase the charge voltage, the primary object is to suppress the reaction between the positive electrode active material and the non-aqueous electrolyte. However, the discharge performance and the storage performance after the high-temperature continuous charge operation are still required to be improved.

Furthermore, in order to increase the capacity and to improve the cycle performance, the addition of zirconium to lithium cobaltate has been disclosed in PTDs 4 and 5; however, the problem may arise in that voltage reduction is increased after the high-temperature continuous charge operation.

### Solution to Problem

A non-aqueous electrolyte secondary battery of the present invention comprises: a positive electrode containing a positive electrode active material; a negative electrode containing a negative electrode active material; a non-aqueous electrolyte; and a separator provided between the positive electrode and the negative electrode. In the non-aqueous electrolyte secondary battery described above, the positive electrode active material includes a lithium transition metal composite oxide and a compound containing a rare earth element fixed to at least part of the surface of the lithium transition metal composite oxide, and in addition, the non-aqueous electrolyte contains a compound having at least two isocyanate groups.

### Advantageous Effects of Invention

The present invention has a significant effect to provide a non-aqueous electrolyte secondary battery which is excellent in discharge performance after a high-temperature continuous charge operation and which suppress a decrease in residual capacity after the high-temperature continuous charge operation.

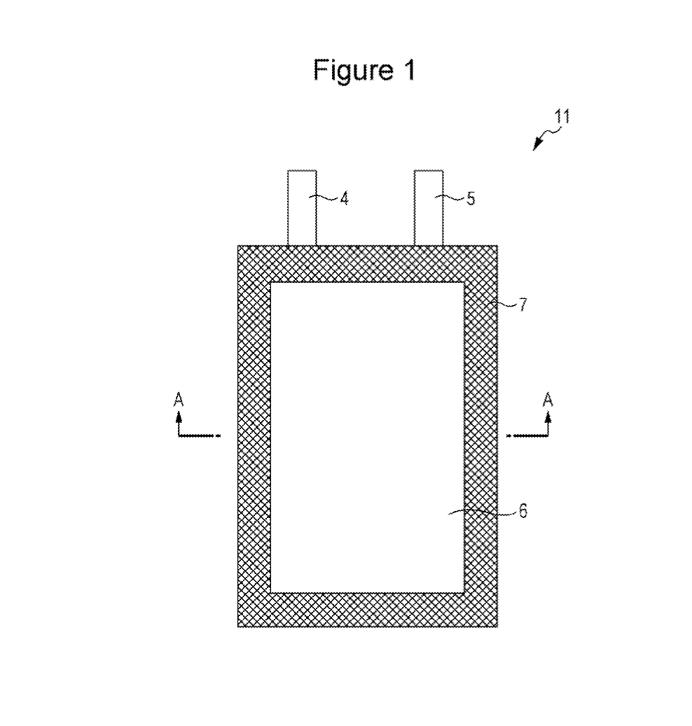

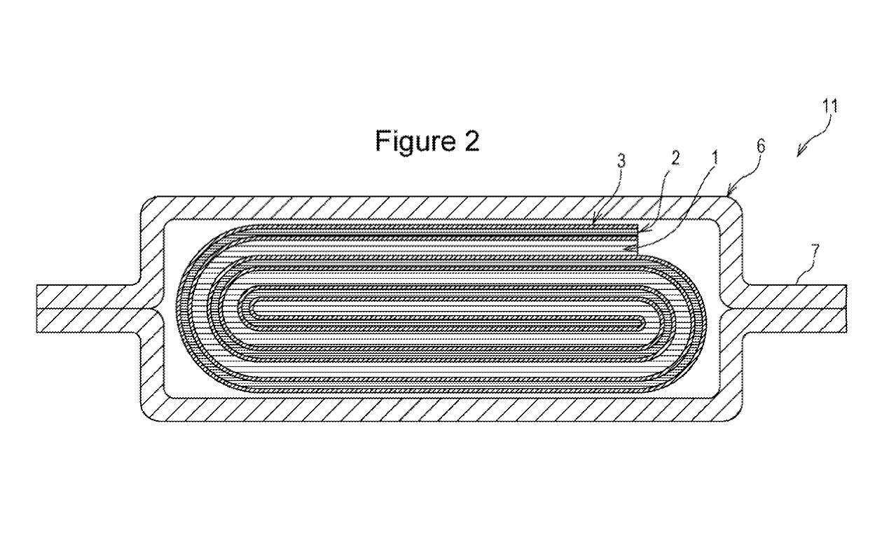

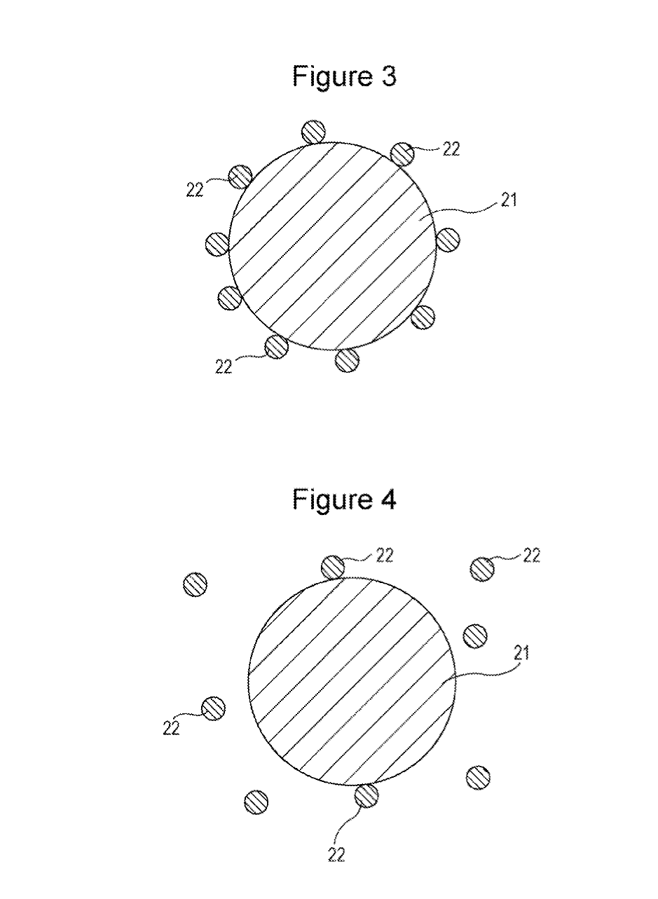

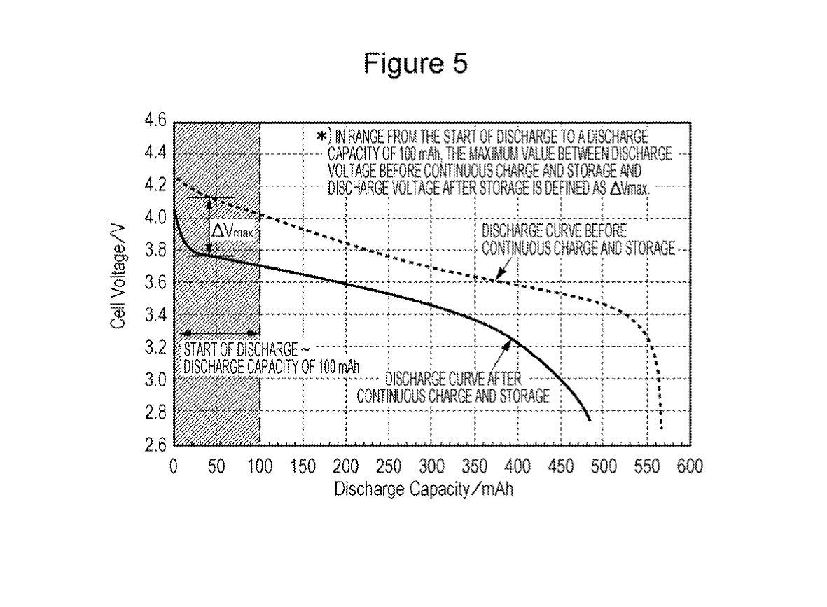

### BRIEF DESCRIPTION OF DRAWINGS

[FIG. 1] FIG. 1 is a front view of a non-aqueous electrolyte secondary battery according to an embodiment of the present invention.

[FIG. 2] FIG. 2 is a cross-sectional view along the line A-A in FIG. 1.

[FIG. 3] FIG. 3 is a view illustrating a surface state of lithium cobaltate of the present invention.

[FIG. 4] FIG. 4 is a view illustrating a surface state of lithium cobaltate of a reference example.

[FIG. 5] FIG. 5 is a graph showing voltage reduction ΔVmax obtained when discharge capacity is measured before and after a high-temperature continuous charge operation.

### DESCRIPTION OF EMBODIMENTS

A non-aqueous electrolyte secondary battery of the present invention includes a positive electrode containing a positive electrode active material, a negative electrode containing a negative electrode active material, a non-aqueous electrolyte, and a separator provided between the positive electrode and the negative electrode, the positive electrode active material includes a lithium transition metal composite oxide and a compound containing a rare earth element fixed to at least part of the surface of the lithium transition metal composite oxide, and in addition, the non-aqueous electrolyte contains a compound having at least two isocyanate groups.

According to the structure as described above, a non-aqueous electrolyte secondary battery can be provided which is excellent in discharge performance after a high-temperature continuous charge operation and which suppresses a decrease in residual capacity after the high-temperature continuous charge operation. The reason for this is that by the compound containing a rare earth element fixed to at least part of the surface of the lithium transition metal composite oxide, the compound having at least two isocyanates is effectively decomposed at the surface of the positive electrode active material, and hence a good quality film is formed on the surface of the positive electrode active material. The reason for this is that the positive electrode active material is protected by the film thus formed, and as a result, an oxidation decomposition reaction of the non-aqueous electrolyte can be suppressed.

In addition, the state in which the compound (hereinafter referred to as “rare earth compound” in some cases) containing a rare earth element, such as erbium, is fixed to part of the surface of the lithium transition metal composite oxide, such as lithium cobaltate particles, indicates the state in which as shown in FIG. 3, particles 22 of the rare earth compound are fixed to the surface of each particle 21 of the lithium transition metal composite oxide. That is, the state described above does not include the state in which as shown in FIG. 4, by simple mixing between the particles 21 of the lithium transition metal composite oxide and the particles 22 of the rare earth compound, some of the particles 22 of the rare earth compound happen to be in contact with the particles 21 of the lithium transition metal composite oxide.

The compound containing a rare earth element is preferably a hydroxide or an oxyhydroxide. The reason for this is that when the rare earth compound is a hydroxide or an oxyhydroxide, under a high-temperature charge condition, the decomposition reaction of the non-aqueous electrolyte at the surface of the positive electrode active material can be suppressed.

The average particle diameter of the compound containing a rare earth element is preferably 100 nm or less. The reason for this is that when the average particle diameter of the compound is more than 100 nm, portions to which the compound is fixed are non-uniformly localized, and as a result, the effect described above cannot be sufficiently obtained.

In addition, the lower limit of the average particle diameter is preferably 1 nm or more and in particular preferably 10 nm or more. The reason for this is that when the average particle diameter is less than 1 nm, the particle size of the compound containing a rare earth element is too small, and as a result, even by a small amount thereof, the surface of the positive electrode active material is excessively covered with the compound.

The number of carbons of the compound having at least two isocyanate groups is preferably 4 to 12. The reason for this is that when the number of carbons is 3 or less, the compound is unstable and is liable to be decomposed, and as a result, the decomposition reaction is difficult to control. In addition, the reason for this is that when the number of carbons is 13 or more, the compound is stable and difficult to be decomposed, and as a result, a preferable protective film is difficult to form on the surface of the positive electrode active material.

In addition, as the compound having isocyanate groups to be used in the present invention, any one of a cyclic compound, a chain compound, and a cyclic compound further having at least one side chain may be used. Among those mentioned above, the cyclic compound is more preferable. The compound having isocyanate groups mentioned above can be easily obtained since generally available on the market. As the chain compound mentioned above, for example, there may be mentioned hexamethylene diisocyanate (hereinafter abbreviated as “HMDI” in some cases), tetramethylene diisocyanate, pentamethylene diisocyanate, heptamethylene diisocyanate, octamethylene diisocyanate, nonamethylene diisocyanate, decamethylene diisocyanate, undecamethylene diisocyanate, and dodecamethylene diisocyanate, and as the cyclic compound mentioned above, for example, there may be mentioned 1,3-bis(isocyanatomethyl)cyclohexane, 1,4-bis(isocyanatomethyl)cyclohexane, 1,3-cyclopentane diisocyanate, 1,3-cyclohexane diisocyanate, and 1,4-cyclohexane diisocyanate.

With respect to the total mass of the non-aqueous electrolyte, the compound having at least two isocyanate groups is preferably contained at a concentration of 0.1 to 5.0 mass %. The reasons for this are that when the concentration is less than 0.1 mass %, the film derived from the compound having isocyanate groups is insufficiently formed on the positive electrode, and that on the other hand, when the concentration is more than 5.0 mass %, the film is excessively formed, and as a result, intercalation and deintercalation reactions of lithium ions into and from the positive electrode are interfered.

The rate of the compound containing a rare earth element to the total amount of the positive electrode active material is preferably 0.005 to 0.8 mass %.

When the rate described above is less than 0.005 mass %, the amount of the compound adhered to the surface of the lithium transition metal composite oxide is too small, and as a result, the effect described above may not be sufficiently obtained in some cases. On the other hand, when the rate described above is more than 0.8 mass %, the surface of the lithium transition metal composite oxide is excessively covered with a material having a low electron conductivity, and as a result, the intercalation and the deintercalation reactions of lithium ions into and from the positive electrode are interfered.

A ring structural portion is preferably located between the isocyanates of the compound having at least two isocyanate groups.

When the ring structural portion is located between the isocyanate groups, the structure of the compound is more stereoscopic as compared to that of a compound in which a chain structural portion is located between the isocyanate groups. Accordingly, since a stereoscopic and preferable film can be formed on the surface of the positive electrode active material, the reaction with the electrolyte can be further suppressed.

(Other Items)

(1) As a method for fixing the above rare earth compound to part of the surface of the lithium transition metal composite oxide (such as lithium cobaltate) to be used as the positive electrode active material, for example, there may be used a method in which a solution containing the rare earth compound is mixed with a solution dispersing particles of the lithium transition metal composite oxide, and a method in which while particles of the lithium transition metal composite oxide are being mixed together, a solution containing the rare earth compound is sprayed to the particles.

By the methods as described above, a hydroxide of the rare earth can be fixed to part of the surface of the lithium transition metal composite oxide. In addition, when the lithium transition metal composite oxide to which the hydroxide of the rare earth is fixed is processed by a heat treatment, the hydroxide of the rare earth fixed to part of the surface is changed into an oxyhydroxide of the rare earth.

As the rare earth compound to be dissolved in a solution used for fixing the hydroxide of the rare earth, for example, a rare earth acetate, a rare earth nitrate, a rare earth sulfate, a rare earth oxide, or a rare earth chloride may be used.

The temperature of the heat treatment is, in general, preferably in a range of 80° C. to 600° C. and in particular preferably in a range of 80° C. to 400° C. When the temperature of the heat treatment is more than 600° C., some of particles of the rare earth compound adhered to the surface of the lithium transition metal composite oxide diffuse into the positive electrode active material, and hence an initial charge-discharge efficiency is degraded. In addition, when the temperature of the heat treatment is more than 600° C., most of the hydroxide and/or the oxyhydroxide of the rare earth, each of which is fixed to part of the surface described above, is turned into an oxide of the rare earth. Accordingly, the compound having at least two isocyanate groups is difficult to be decomposed, and as a result, a preferable film is difficult to form on the surface of the positive electrode active material. On the other hand, when the temperature of the heat treatment is less than 80° C., the time required therefor is increased, and as a result, a manufacturing cost is increased.

In addition, as the positive electrode active material, besides lithium cobaltate, a lithium nickelate cobaltate manganate may also be used. As the lithium nickelate cobaltate manganate, for example, a compound having a molar ratio of nickel, cobalt, and manganese of 1:1:1 or 5:3:2 may be used, and in particular, a compound having a nickel ratio higher than a cobalt ratio and/or a manganese ratio is preferably used so as to increase the positive electrode capacity.

In addition, a lithium nickelate manganate aluminate, a lithium nickelate cobaltate aluminate, a lithium iron phosphate, and a lithium manganese phosphate may also be mentioned by way of example. In addition, those compounds mentioned above may be used alone or in combination.

(2) A solvent of the non-aqueous electrolyte to be used in the present invention is not particularly limited, and a solvent which has been used in the past for a non-aqueous electrolyte secondary battery may be used. For example, there may be used cyclic carbonates, such as ethylene carbonate, propylene carbonate, butylene carbonate, and vinylene carbonate; chain carbonates, such as dimethyl carbonate, methyl ethyl carbonate, and diethyl carbonate; compounds each containing an ester, such as methyl acetate, ethyl acetate, propyl acetate, methyl propionate, ethyl propionate, and γ-butyrolactone; compounds each containing a sulfonic group, such as propanesultone; compounds each containing an ether, such as 1,2-dimethoxyethane, 1,2-diethoxyethane, tetrahydrofuran, 1,2-dioxane, 1,4-dioxane, and 2-methyltetrahydrofuran; compounds each containing a nitrile, such as butyronitrile, valeronitrile, n-heptanenitrile, succinonitrile, glutarnitrile, adiponitrile, pimelonitrile, 1,2,3-propanetricarbonitrile, and 1,3,5-pentanetricarbonitrile; and compounds each containing an amide, such as dimethylformamide. In particular, among those mentioned above, a solvent in which at least one hydrogen atom is replaced with a fluorine atom is preferably used.

In addition, those solvents mentioned above may be used alone or in combination, and in particular, a solvent in which a cyclic carbonate and a chain carbonate are used in combination and a solvent in which a small amount of a compound containing a nitrile and/or a compound containing an ether is used in combination with the solvent mentioned above are preferable.

In addition, as a solute of the non-aqueous electrolyte, a solute which has been used in the past may be used. For example, LiPF₆, LiBF₄, LiN (SO₂CF₃)₂, LiN(SO₂C₂F₅)₂, LiPF₆₋ₓ(CₙF₂ₙ₋₁)ₓ (in this case, 1<x<6 holds, and n is an integer of 1 or 2) may be mentioned, and in addition, those solutes may be used alone or in combination. Although the concentration of the solute is not particularly limited, 0.8 to 1.7 moles per one liter of the electrolyte is preferable.

(3) For the negative electrode to be used in the present invention, a material which has been used in the past may be used. For example, there may be mentioned a carbon material capable of intercalating and deintercalating lithium, a metal capable of forming an alloy with lithium, an alloy containing the metal mentioned above, or a compound of the above alloy. Furthermore, a mixture containing the compounds mentioned above may also be used.

As the carbon material described above, for example, graphites, such as natural graphite, non-graphatizable carbon, and artificial graphite, and cokes may be used, and as the alloy compound described above, for example, a compound containing at least one metal capable of forming an alloy with lithium may be mentioned. In particular, as an element capable of forming an alloy with lithium, silicon and tin are preferable, and for example, silicon oxide and tin oxide, each of which is formed from the above element in combination with oxygen, may also be used. In addition, a mixture of the carbon material and the compound of silicon and/or tin may also be used.

Besides those compounds mentioned above, although the energy density is decreased, as the negative electrode material, there may also be used a material having a high charge-discharge potential of metal lithium, such as lithium titanate, as compared to that of a carbonaceous material or the like.

(4) At the interface between the positive electrode and the separator or the interface between the negative electrode and the separator, a layer may be formed from an inorganic filler which has been used in the past. As the filler, an oxide or a phosphate compound formed from at least one of titanium, aluminum, silicon, magnesium, and the like, which has been used in the past, may be used, and in addition, a compound formed by treating the surface of the above oxide or phosphate compound with a hydroxide and/or the like may also be used.

As a method for forming the filler layer, for example, there may be used a method in which a filler-containing slurry is directly applied to the positive electrode, the negative electrode, or the separator or a method in which a sheet formed from the filler is adhered to the positive electrode, the negative electrode, or the separator.

(5) As the separator to be used in the present invention, a separator which has been used in the past may be used. In particular, besides a separator formed of a polyethylene, a separator formed of a polyethylene layer and a polypropylene layer provided on a surface thereof and a separator formed by applying a resin, such as an aramide resin, on a surface of a polyethylene separator may also be used.

(6) As described below, as the rare earth hydroxide or oxyhydroxide, experimental data of hydroxides or oxyhydroxides of two types of rare earth elements, erbium and lanthanum, are shown. However, the present invention is not limited to those compounds described above, and the effect similar to that described above may also be obtained from praseodymium, neodymium, samarium, europium, gadolinium, terbium, dysprosium, holmium, thulium, ytterbium, or lutetium. The reason for this is believed that by the hydroxide or oxyhydroxide of the rare earth element mentioned above, the compound having at least two isocyanate groups is effectively decomposed on the surface of the positive electrode active material, and as a result, a preferable film can be formed on the surface of the positive electrode active material.

### EXAMPLES

The non-aqueous electrolyte secondary battery of the present invention is not limited to the following modes and may be appropriately changed without departing from the scope of the present invention.

### Example 1

[Formation of Positive Electrode]

Lithium cobaltate particles in an amount of 1,000 g were prepared and were then added to 3.0 L of purified water, followed by stirring, so that a suspension dispersing the lithium cobaltate was obtained. Next, a solution containing 200 mL of purified water and 1.81 g of erbium nitrate pentahydrate [Er(NO₃)₃.5H₂O] was entirely added to this suspension over 1 hour. In this process, in order to adjust the solution in which the lithium cobaltate was dispersed to have a pH of 9, a nitric acid aqueous solution at a concentration of 10 mass % or a sodium hydroxide aqueous solution at a concentration of 10 mass % was appropriately added.

Next, after the addition of the erbium nitrate pentahydrate solution, suction filtration was performed, and water washing was further performed, followed by drying of an obtained powder at 120° C., so that a powder in which an erbium hydroxide compound was fixed to part of the surface of the lithium cobaltate was obtained. Subsequently, the obtained powder was processed by a heat treatment at 300° C. for 5 hours in air. By the heat treatment at 300° C. as described above, since the erbium hydroxide is entirely or mostly turned into an erbium oxyhydroxide, the state in which the erbium oxyhydroxide was fixed to part of the surface of each lithium cobaltate particle was obtained. However, since partially remaining in some cases, the erbium hydroxide might be fixed to part of the surface of each lithium cobaltate particle in some cases (erbium oxyhydroxide and erbium hydroxide were collectively referred to as “erbium compound” in some cases).

In addition, the erbium compound fixed to the surface of the lithium cobaltate was 0.068 mass % based on the erbium element with respect to the lithium cobaltate. In addition, according to the observation result obtained by using a SEM, the erbium compound was uniformly dispersed on and fixed to the surfaces of the lithium cobaltate particles, and the particle diameter of the erbium compound was 100 nm or less.

A positive electrode active material thus obtained, acetylene black functioning as a positive electrode conductive agent, and a poly(vinylidene fluoride) (PVdF) functioning as a binding agent were kneaded together in N-methyl-2-pyrrolidone functioning as a dispersion medium to prepare a positive electrode slurry. In this step, the mass ratio of the positive electrode active material, the positive electrode conductive agent, and the binding agent was set to 95:2.5:2.5. Next, after the positive electrode slurry was uniformly applied to two surfaces of a positive electrode collector formed of an aluminum foil and was then dried, rolling was performed by rolling rollers, and a positive electrode collector tab was fitted to the collector, so that a positive electrode was formed. In addition, the packing density of the positive electrode was set to 3.60 g/cm³.

[Formation of Negative Electrode]

After artificial graphite functioning as a negative electrode active material and SBR (styrene-butadiene rubber) functioning as a binding agent were added to an aqueous solution containing purified water and CMC (sodium carboxymethylcellulose) functioning as a thickening agent, kneading was performed, so that a negative electrode slurry was prepared. In this process, the mass ratio of the negative electrode active material, the binding agent, and the thickening agent was set to 98:1:1. Next, after the negative electrode slurry was uniformly applied to two surfaces of a negative electrode collector formed of a copper foil and was then dried, rolling was performed by rolling rollers, and a negative electrode collector tab was fitted to the collector, so that a negative electrode was formed. In addition, the packing density of the negative electrode was set to 1.60 g/cm³.

[Preparation of Non-Aqueous Electrolyte]

Lithium phosphate hexafluoride (LiPF₆) was dissolved in a mixed solvent containing ethylene carbonate (EC) and ethyl methyl carbonate (EMC) at a volume ratio of 2:8 to obtain a concentration of 1.0 mole/L, and in addition, vinylene carbonate (VC) and hexamethylene diisocyanate (HMDI) were added to the above mixed solvent so as to each have a concentration of 1.0 mass %, thereby preparing a non-aqueous electrolyte.

[Formation of Battery]

The positive electrode and the negative electrode, each of which was obtained as described above, were wound to face each other with a separator provided therebetween, the separator being formed of a polyethylene pore film having a thickness of 22 μm, so that a wound body was formed. Next, in a glow box in an argon atmosphere, the wound body was sealed in an aluminum laminate together with the above non-aqueous electrolyte, so that a non-aqueous electrolyte secondary battery having a thickness of 3.6 mm, a width of 3.5 cm, and a length of 6.2 cm was obtained.

The battery formed as described above was called a battery A1.

In this example, as shown in FIGS. 1 and 2, as a concrete structure of the non-aqueous electrolyte secondary battery 11, a positive electrode 1 and a negative electrode 2 were arranged to face each other with a separator 3 provided therebetween, and a flat electrode body formed of the positive and the negative electrodes 1 and 2 and the separator 3 was impregnated with the non-aqueous electrolyte. A positive electrode collector tab 4 and a negative electrode collector tab 5 were connected to the positive electrode 1 and the negative electrode 2, respectively, to form a structure as a secondary battery capable of performing charge and discharge. In addition, the electrode body was disposed in a space of an aluminum laminate package member 6 having a sealing portion 7 obtained by heat sealing of peripheral portions of the package member.

### Example 2

A battery was formed in a manner similar to that of Example 1 except that 1,3-bis(isocyanatomethyl)cyclohexane was used as the additive of the non-aqueous electrolyte instead of using hexamethylene diisocyanate (HMDI).

Hereinafter, the battery formed as described above was called a battery A2.

### Example 3

A battery was formed in a manner similar to that of Example 2 except that as the positive electrode active material, a lanthanum compound was fixed to part of the surface of the lithium cobaltate instead of using the erbium compound.

Incidentally, except that lanthanum nitrate hexahydrate was used instead of using erbium nitrate pentahydrate, a positive electrode active material which was surface-modified with the lanthanum compound was formed by a method similar to that for forming the positive electrode active material which was surface-modified with the erbium compound.

Hereinafter, the battery formed as described above was called a battery A3.

In addition, according to the analytical result obtained by an ICP method, the rate of the lanthanum compound to the lithium cobaltate was 0.057 mass % based on the lanthanum element (by this mass rate, the molar amount of lanthanum to the lithium cobaltate was the same as that of erbium to the lithium cobaltate of the battery A1). In addition, according to the result obtained by using a SEM, it was found that particles of the lanthanum compound having a size of 100 nm or less were uniformly dispersed on and fixed to the surface of the lithium cobaltate.

### Example 4

A battery was formed in a manner similar to that of Example 3 except that dodecamethylene diisocyanate was used as the additive of the non-aqueous electrolyte instead of using hexamethylene diisocyanate (HMDI).

Hereinafter, the battery formed as described above was called a battery A4.

### Comparative Example 1

A battery was formed in a manner similar to that of Example 1 except that hexamethylene diisocyanate (HMDI) was not added when the non-aqueous electrolyte was prepared.

Hereinafter, the battery formed as described above was called a battery Z1.

### Comparative Example 2

A battery was formed in a manner similar to that of Example 1 except that as the positive electrode active material, a zirconium compound was fixed to part of the surface of the lithium cobaltate.

Incidentally, except that zirconium oxynitrate dihydrate was used instead of using erbium nitrate pentahydrate, a positive electrode active material which was surface-modified with the zirconium compound was formed by a method similar to that for forming the positive electrode active material which was surface-modified with the erbium compound.

Hereinafter, the battery formed as described above was called a battery Z2.

In addition, the rate of the zirconium compound to the lithium cobaltate was 0.037 mass % based on the zirconium element (by this mass rate, the molar amount of zirconium to the lithium cobaltate was the same as that of erbium to the lithium cobaltate of the battery A1). In addition, according to the result obtained by using a SEM, it was found that the zirconium compound was uniformly dispersed on and fixed to the surface of the lithium cobaltate.

### Comparative Example 3

A battery was formed in a manner similar to that of Comparative Example 2 except that hexamethylene diisocyanate (HMDI) was not added when the non-aqueous electrolyte was prepared.

Hereinafter, the battery formed as described above was called a battery Z3.

### Comparative Example 4

A battery was formed in a manner similar to that of Example 3 except that 1,3-bis(isocyanatomethyl)cyclohexane was not added when the non-aqueous electrolyte was prepared.

Hereinafter, the battery formed as described above was called a battery Z4.

### Comparative Example 5

A battery was formed in a manner similar to that of Example 1 except that when the non-aqueous electrolyte was prepared, hexyl isocyanate (compound having only one isocyanate group) was added instead of using hexamethylene diisocyanate (HMDI).

Hereinafter, the battery formed as described above was called a battery Z5.

### Comparative Example 6

A battery was formed in a manner similar to that of Example 1 except that after Li₂CO₃ (lithium salt), CO₃O₄ (tricobalt tetraoxide), and ZrO₂ (zirconium oxide) were mixed together using an Ishikawa-type grinding mortar to have a molar ratio Li:Co:Zr of 1:0.995:0.005 and were then processed by a heat treatment at 850° C. for 20 hours in an air atmosphere, the mixture thus obtained was pulverized to form a positive electrode active material. In addition, when the positive electrode active material was observed by using a TEM, the presence of zirconium was confirmed at the interfaces between particles of lithium cobaltate.

Hereinafter, the battery formed as described above was called a battery Z6.

### Comparative Example 7

A battery was formed in a manner similar to that of Comparative Example 6 except that hexamethylene diisocyanate (HMDI) was not added when the non-aqueous electrolyte was prepared.

Hereinafter, the battery formed as described above was called a battery Z7.

[Experiment]

Charge and discharge operations and the like were performed on the batteries A1 to A4 and Z1 to Z7 in accordance with the following procedure to obtain voltage reduction ΔVmax and a residual capacity rate, and the results thereof are shown in Table 1.

(1) A charge-discharge cycle test was performed once under the following charge and discharge conditions to measure an initial discharge capacity (Q₀). In addition, the temperature at the charge and discharge was set to room temperature.
Charge Conditions

Constant current charge was performed at a current of 1.0 It (750 mA) until the battery voltage reached 4.40 V, and constant voltage charge was then performed at a constant voltage of 4.40 V until the current reached [1/20] It (37.5 mA).
Discharge Conditions

Constant current discharge was performed at a current of 1.0 It (750 mA) until the battery voltage reached 2.75 V.
Rest

A rest period between the charge and the discharge was set to 10 minutes.

(2) After the initial charge capacity (Q₀) was measured, the battery was placed in a constant-temperature bath at 60° C. for 1 hour. Subsequently, in an atmosphere at 60° C., charge was performed to 4.40 V at a constant current of 750 mA and was further performed at a constant voltage of 4.4 V so that the total charge time was 80 hours.

Subsequently, after the battery was recovered from the constant-temperature bath and was then cooled to room temperature, a discharge capacity (Q₁) after the continuous charge test was measured, and the residual capacity rate was obtained from the following equation.

Residual Capacity Rate (%)=[Discharge Capacity (Q₁) after Continuous Charge Test/Charge Capacity (Q₀) before Continuous Charge Test]×100

In addition, as shown in FIG. 5, in a range from the start of discharge to a discharge capacity of 100 mAh, the maximum difference between a voltage obtained at discharge capacity measurement after the high-temperature continuous charge operation and a voltage obtained at discharge capacity measurement before the high-temperature continuous charge operation was defined as voltage reduction ΔVmax, and this voltage reduction ΔVmax was obtained.

In addition, when this voltage reduction ΔVmax is large, in a battery designed to contain a small amount of an electrolyte, the reduction in discharge voltage occurs more remarkably, and since the voltage reaches a discharge cut-off voltage at an initial discharge stage, the battery capacity may be remarkably decreased in some cases. Hence, in order to improve the charge-discharge performance of the battery, the discharge voltage ΔVmax must be decreased.

TABLE 1

| | ELEMENT | | | |
|---|---|---|---|---|
| | FIXED TO | | | |
| | SURFACE OF | | VOLTAGE | RESIDUAL |
| | LITHIUM | | REDUCTION | CAPACITY |
| BATTERY | COBALTATE | ADDITIVE | ΔVmax (mV) | RATE (%) |
| A1 | Er | HEXAMETHYLENE DIISOCYANATE | 80 | 95.4 |
| A2 | Er | 1.3-BIS(ISOCYANATOMETHYL)CYCLOHEXANE | 50 | 94.2 |
| A3 | La | 1.3-BIS(ISOCYANATOMETHYL)CYCLOHEXANE | 165 | 93.7 |
| A4 | La | DODECAMETHYLENE DIISOCYANATE | 155 | 86.0 |
| Z1 | Er | NONE | 130 | 83.0 |
| Z2 | Zr | HEXAMETHYLENE DIISOCYANATE | 300 | 84.6 |
| Z3 | Zr | NONE | 250 | 74.1 |
| Z4 | La | NONE | 190 | 77.0 |
| Z5 | Er | HEXYL ISOCYANATE | 380 | 79.2 |
| Z6 | Zr (PARTICLE | HEXAMETHYLENE DIISOCYANATE | 740 | 84.6 |
| | INTERFACE) | | | |
| Z7 | Zr (PARTICLE | NONE | 720 | 70.0 |
| | INTERFACE) | | | |

As apparent from the results shown in Table 1, compared to the batteries Z1 to Z7, each of which uses the non-aqueous electrolyte containing no compound having at least two isocyanate groups and/or the positive electrode active material in which the rare earth compound is not fixed to part of the surface of the lithium cobaltate, it is found that in the batteries A1 to A4, each of which uses the non-aqueous electrolyte containing the compound having at least two isocyanate groups and the positive electrode active material in which the erbium compound or the lanthanum compound is fixed to part of the surface of the lithium cobaltate, battery performances obtained when the continuous charge is performed at a high temperature of 60° C. are excellent. Hereinafter, the results will be discussed in detail.

When the battery A1 is compared to the battery Z1, each of which uses the positive electrode active material in which the erbium compound is fixed to part of the surface of the lithium cobaltate, it is found that in the battery A1 in which the compound (hexamethylene diisocyanate) having at least two isocyanate groups is contained in the non-aqueous electrolyte, the residual capacity rate is significantly improved, and the voltage reduction ΔVmax at discharge after the high-temperature continuous charge operation is also significantly suppressed as compared to those in the battery Z1 in which the compound having at least two isocyanate groups is not contained in the non-aqueous electrolyte. The reasons for this are believed that in the battery A1, the compound having at least two isocyanate groups is effectively decomposed to form a preferable film on the surface of the positive electrode active material and that, on the other hand, in the battery Z1, since the compound having at least two isocyanate groups is not added, a preferable film is not formed on the surface of the positive electrode active material.

In addition, it is also found that in the battery A2 that uses 1,3-bis(isocyanatomethyl)cyclohexane, which has a ring structural portion located between the isocyanate groups, as the compound having at least two isocyanate groups instead of using hexamethylene diisocyanate, which has a chain structural portion located between the isocyanate groups, the effect similar to that of the battery A1 can also be obtained. Hence, by any structural portion located between the isocyanate groups, such as a ring structural portion, a chain structural portion, or a ring structural portion further having at least one side chain, the effect of the present invention can be obtained.

However, when the battery A1 and the battery A2 are compared to each other, it is found that in the battery A2 that uses 1,3-bis(isocyanatomethyl)cyclohexane, which has a ring structural portion located between the isocyanate groups, the voltage reduction ΔVmax at discharge is further suppressed as compared to that in the battery A1 that uses hexamethylene diisocyanate (HMDI), which has a chain structural portion located between the isocyanate groups.

The reason for this is believed that since the ring structural portion located between the isocyanate groups is more stereoscopic than the chain structural portion located therebetween, a stereoscopic and preferable film can be formed on the surface of the positive electrode active material, and hence the reaction with the electrolyte can be further suppressed. From the results described above, it is found that the ring structural portion located between the isocyanate groups is preferable as compared to the chain structural portion located therebetween.

In addition, when the battery Z1 and the battery Z5 are compared to each other, each of which uses the positive electrode active material in which the erbium compound is fixed to part of the surface of the lithium cobaltate, it is found that in the battery Z5 in which the compound (hexyl isocyanate) having only one isocyanate group is contained in the non-aqueous electrolyte, the voltage reduction ΔVmax at discharge is large, and the residual capacity rate is also decreased as compared to those in the battery Z1 in which any compound having an isocyanate group is not contained in the non-aqueous electrolyte. From the results described above, it is found that when the positive electrode active material in which the compound containing a rare earth element is fixed to at least part of the surface of the lithium cobaltate is used, the compound having at least two isocyanate groups is required to be contained in the non-aqueous electrolyte so as to obtain the effect of the present invention. That is, although the positive electrode active material in which the compound containing a rare earth element is fixed to at least part of the surface of the lithium cobaltate is used, if the compound contained in the non-aqueous electrolyte has only one isocyanate group, the effect of the present invention cannot be sufficiently obtained.

The reason for this is believed that since the compound (hexyl isocyanate) having only one isocyanate group has not good reactivity with the compound containing a rare earth element, a preferable film cannot be formed on the surface of the positive electrode active material.

Furthermore, when the batteries A3, A4, and Z4 are compared to each other, each of which uses the positive electrode active material in which the lanthanum compound, which contains an element different from erbium contained in the erbium compound, is fixed to part of the surface of the lithium cobaltate, it is found that in the batteries A3 and A4, in each of which the compound having at least two isocyanate groups is contained in the non-aqueous electrolyte, the residual capacity rate is significantly improved, and the voltage reduction ΔVmax at discharge after the high-temperature continuous charge operation is also significantly suppressed as compared to those in the battery Z4 in which the compound having at least two isocyanate groups is not contained in the non-aqueous electrolyte.

However, when the batteries A2 and Z1 are compared to each other, each of which uses the positive electrode active material in which the erbium compound is fixed to part of the surface of the lithium cobaltate, in the battery A2 in which 1,3-bis(isocyanatomethyl)cyclohexane is contained in the non-aqueous electrolyte, the voltage reduction ΔVmax is improved by 80 mV (130-50 mV) as compared to that in the battery Z1 in which 1,3-bis(isocyanatomethyl)cyclohexane is not contained in the non-aqueous electrolyte. On the other hand, when the batteries A3 and Z4 are compared to each other, each of which uses the positive electrode active material in which the lanthanum compound is fixed to part of the surface of the lithium cobaltate, in the battery A3 in which 1,3-bis(isocyanatomethyl)cyclohexane is contained in the non-aqueous electrolyte, the voltage reduction ΔVmax is improved only by 25 mV (190-165 mV) as compared to that in the battery Z4 in which 1,3-bis(isocyanatomethyl)cyclohexane is not contained in the non-aqueous electrolyte.

As described above, even if 1,3-bis(isocyanatomethyl)cyclohexane is contained in the non-aqueous electrolyte, the degree of improvement in voltage reduction ΔVmax is increased when the erbium compound is fixed as compared to the case in which the lanthanum compound is fixed. Hence, as the compound to be fixed to at least part of the surface of the lithium cobaltate, the erbium compound is preferable as compared to the lanthanum compound.

Next, when the battery Z2 and the battery Z3 are compared to each other, each of which uses the positive electrode active material in which the zirconium compound is fixed to part of the surface of the lithium cobaltate, it is found that in the battery Z2 in which hexamethylene diisocyanate (HMDI) is contained in the non-aqueous electrolyte, although the residual capacity rate is improved, the voltage reduction ΔVmax is large as compared to that in the battery Z3 in which hexamethylene diisocyanate (HMDI) is not contained in the non-aqueous electrolyte. From the results described above, it is found that in order to form a preferable film on the surface of the positive electrode active material, the positive electrode active material in which the compound containing a rare earth element is fixed to at least part of the surface of the lithium cobaltate is necessarily used. Although the details have not been clearly understood, the reason for this is believed that when the zirconium compound is fixed to part of the surface of the lithium cobaltate, hexamethylene diisocyanate (HMDI) is not effectively decomposed, and hence a preferable film cannot be formed on the surface of the positive electrode active material.

In addition, when the batteries Z6 and Z7 are compared to each other, in each of which zirconium is present at interfaces between particles of the positive electrode active material, it is found that in the battery Z6 in which hexamethylene diisocyanate (HMDI) is contained in the non-aqueous electrolyte, although the residual capacity rate is improved, the voltage reduction ΔVmax is large as compared to that in the battery Z7 in which hexamethylene diisocyanate (HMDI) is not contained in the non-aqueous electrolyte.

From the results thus obtained, the effect of the present invention can be particularly obtained when the positive electrode active material is used in which the compound containing a rare earth element is fixed to at least part of the surface of the lithium transition metal composite oxide, such as lithium cobaltate, and when the compound containing at least two isocyanate groups is contained in the non-aqueous electrolyte.

### INDUSTRIAL APPLICABILITY

The present invention can be expected to be increasingly applied to a drive power source of a mobile information terminal, such as a mobile phone, a notebook personal computer, or a PDA; a high-output drive power source for a HEV or an electric power tool; and a storage battery device formed in combination with a solar cell and/or an electrical power system.

### REFERENCE SIGNS LIST

1 positive electrode
2 negative electrode
3 separator
4 positive electrode collector tab
5 negative electrode collector tab
6 aluminum laminate package member
21 particle of lithium transition metal composite oxide
22 particle of compound containing rare earth element

1. A non-aqueous electrolyte secondary battery comprising:
a positive electrode containing a positive electrode active material;
a negative electrode containing a negative electrode active material;
a non-aqueous electrolyte; and
a separator provided between the positive electrode and the negative electrode,
wherein the positive electrode active material includes a lithium transition metal composite oxide and a compound containing a rare earth element fixed to at least part of the surface of the lithium transition metal composite oxide, and the non-aqueous electrolyte contains a compound having at least two isocyanate groups.

2. The non-aqueous electrolyte secondary battery according to claim 1,
wherein the compound containing a rare earth element is a hydroxide or an oxyhydroxide.

3. The aqueous electrolyte secondary battery according to claim 1,
wherein the compound containing a rare earth element has an average particle diameter of 100 nm or less.

4. The non-aqueous electrolyte secondary battery according to claim 1,
wherein the compound containing at least two isocyanate has 4 to 12 carbon atoms.

5. The non-aqueous electrolyte secondary battery according to claim 1,
wherein with respect to the total mass of the non-aqueous electrolyte, the compound containing at least two isocyanate groups has a concentration of 0.1 to 5.0 mass %.

6. The non-aqueous electrolyte secondary battery according to claim 1,
wherein the rare earth element includes erbium.

7. The non-aqueous electrolyte secondary battery according to claim 1,
wherein the rate of the compound containing a rare earth element to the total mass of the positive electrode active material is 0.005 to 0.8 mass %.

8. The non-aqueous electrolyte secondary battery according to claim 1,
wherein the compound containing at least two isocyanate groups has a ring structural portion located between the isocyanate groups.

9. The non-aqueous electrolyte secondary battery according to claim 8,
wherein the compound containing at least two isocyanate groups includes 1,3-cyclohexane diisocyanate.
